(19) United States
(12) Patent Application Publication
(10) Pub. No.: US 2008/0311766 A1
(43) Pub. Date: Dec. 18, 2008

(54) Light Emitting Diode Mounting Seat and Method For Making The Same

(76) Inventor: Mei-Yuh Luo, Hsinchu City (TW)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/132,019

(22) Filed: Jun. 3, 2008

(30) Foreign Application Priority Data
Jun. 12, 2007 (TW) 096121132

(51) Int. Cl. H01R 12/00; H01K 3/22

(52) U.S. Cl. 439/56; 29/848

(57) ABSTRACT

A light emitting diode mounting seat includes: a base having a conductive main part of a metallic material and a lead-mounting part of a non-conductive material containing a compound of the metallic material; and a conductive lead mounted on the lead-mounting part. The compound is an oxide of the metallic material.

### CROSS-REFERENCE TO RELATED APPLICATION

This application claims priority of Taiwanese application no. 096121132, filed on Jun. 12, 2007.

### BACKGROUND OF THE INVENTION

1. Field of the Invention

The invention relates to a light emitting diode mounting seat including an anodized base and to a method for making the same.

2. Description of the Related Art

Referring to FIG. 1, a conventional light emitting diode mounting seat 1 includes a base 11 having a diode-mounting surface 111 for mounting of a light emitting diode 10 thereon, two conductive leads 12 electrically connected to the light emitting diode 10, two insulators 13 disposed on the base 11 to isolate the conductive leads 12 from the base 11 for preventing a short circuit therebetween, and a resin material 14 for securing the conductive leads 12 to the base 11.

However, the use of the insulators 13 increases the production cost considerably. Moreover, mounting of the insulators 13 on the base 11 becomes relatively difficult when the size of the base 11 becomes smaller for miniaturization purposes.

In addition, since a contact surface 15 between the resin material 14 and the base 11 is flat, and since the difference in the thermal expansion coefficients thereof is relatively large, separation of the resin material 14 from the base 11 is likely to occur after a period of time due to repeated thermal expansion and contraction.

Furthermore, mass production of the conventional light emitting diode mounting seat 1 is normally performed by the steps of: forming a plurality of the bases 11 that are separate from each other; installing the insulators 13 on each of the bases 11; inserting the bases 11 into a resin forming mold (not shown) one after another; placing a lead frame (not shown) having a plurality of the conductive leads 12 into the resin forming mold; injecting a resin material into the mold so as to form a semi-finished product; and cutting the semi-finished product to form a plurality of the light emitting diode mounting seats 1. However, the step of inserting the bases 11 into the resin forming mold is time-consuming, and the productivity of the conventional mass production method is unsatisfactory.

### SUMMARY OF THE INVENTION

Therefore, an object of the present invention is to provide a light emitting diode mounting seat that can overcome the aforesaid drawbacks associated with the prior art.

Another object of the present invention is to provide a method for making the light emitting diode mounting seat.

According to one aspect of the present invention, there is provided a light emitting diode mounting seat comprising: a base having a conductive main part of a metallic material and a lead-mounting part of a non-conductive material containing a compound of the metallic material; and a conductive lead mounted on the lead-mounting part.

According to another aspect of the present invention, there is provided a method for making a light emitting diode mounting seat, comprising:

(a) forming a metallic extrudate through thermal extruding techniques; (b) punching the metallic extrudate to form a base unit including a plurality of base elements; (c) treating the base unit in such a manner to form each of the base elements with a conductive main part and a non-conductive lead-mounting part; (d) assembling the base unit with a lead frame to form an assembly, and placing the assembly into a mold; (e) injecting a resin material into the mold so as to form a semi-finished product; and (f) cutting the semi-finished product so as to form a plurality of the light emitting diode mounting seats.

### BRIEF DESCRIPTION OF THE DRAWINGS

Other features and advantages of the present invention will become apparent in the following detailed description of the preferred embodiment with reference to the accompanying drawings, of which:

FIG. 1 is a cross-sectional view of a conventional light emitting diode mounting seat;

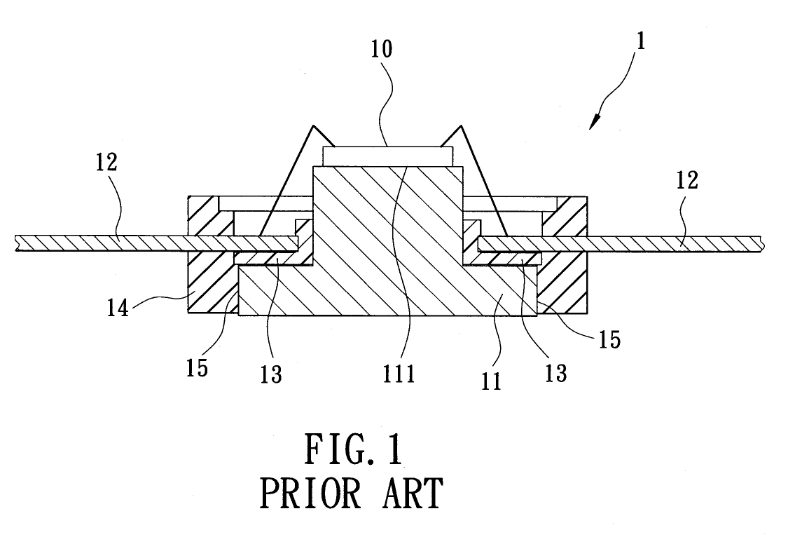

FIG. 2 is a top view of the preferred embodiment of a light emitting diode mounting seat according to this invention;

FIG. 3 is a cross-sectional view taken along line III-III in FIG. 2;

FIG. 4 is a fragmentary schematic top view of a metallic extrudate formed by thermal extrusion according to a method for making the light emitting diode mounting seat of the present invention;

FIG. 5 is a schematic top view of a base unit formed by punching the extrudate of FIG. 4 according to the method for making the light emitting diode mounting seat of the present invention;

FIG. 6 is a fragmentary schematic top view of a lead frame to be assembled with the base unit of FIG. 5;

FIG. 7 is a schematic top view to illustrate an assembly of the base unit and the lead frame; and

FIG. 8 is a fragmentary schematic top view of a semi-finished product formed by forming a resin material to bond the base unit and the lead frame together according to the method for making the light emitting diode mounting seat of the present invention.

### DETAILED DESCRIPTION OF THE PREFERRED EMBODIMENT

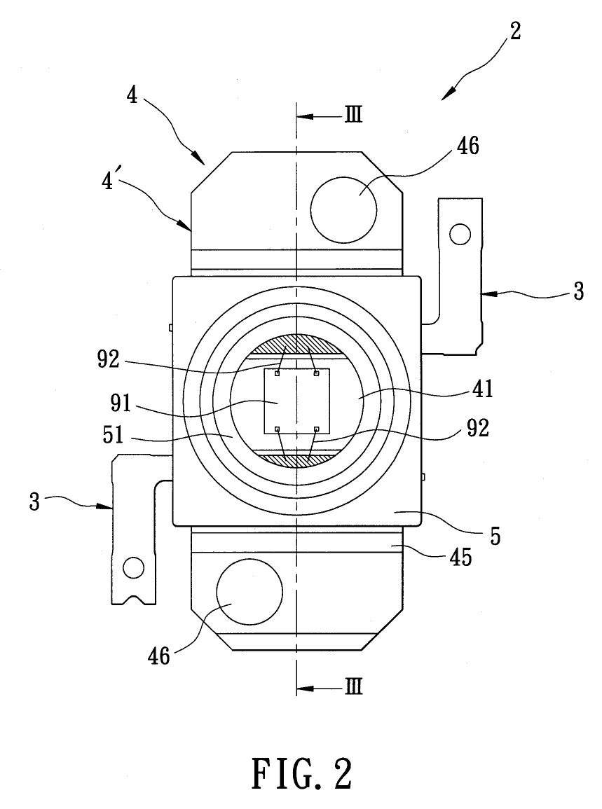

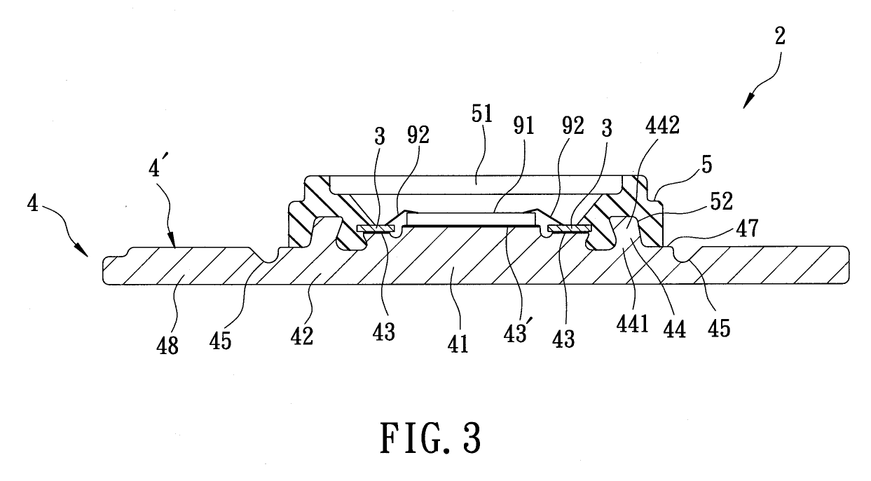

Referring to FIGS. 2 and 3, the preferred embodiment of a light emitting diode mounting seat 2 according to this invention is shown to include a base 4 and a pair of conductive leads 3. The base 4 has a conductive main part 4′ of a metallic material and two lead-mounting parts 43 of a non-conductive material containing a compound of the metallic material. The conductive leads 3 are mounted on the lead-mounting parts 43, respectively.

In this embodiment, the light emitting diode mounting seat 2 further includes a resin material 5 bonded to the conductive leads 3 and the base 4 for securing the conductive leads 3 to the base 4.

As shown in FIG. 3, the base 4 and the resin material 5 engage each other in a tongue-and-groove engaging manner. In this embodiment, the main part 4′ of the base 4 is formed with a pair of protrusions 44, and the resin material 5 is formed with a pair of recesses 52 for extension of the protrusions 44 therein, respectively. In other embodiments, the tongue-and groove engaging manner can be reversed such that the resin material 5 is formed with a pair protrusions (not shown) and that the main part 4′ of the base 4 is formed with a pair of recesses (not shown).

The main part 4′ of the base 4 has an upper surface 47. The protrusions 44 protrude from the upper surface 47. Each of the protrusions 44 has a root end 441 and a free end 442. The root end 441 terminates at the upper surface 47 of the base 4. The free end 442 is opposite to the root end 441 and has a cross-section greater than that of the root end 441.

The main part 4′ of the base 4 further has a central portion 41, two opposite engaging portions 42, and two end portions 48. The two opposite engaging portions 42 extend from two opposite sides of the central portion 41, respectively, and engage the resin material 5. The end portions 48 extend respectively from the engaging portions 42. Each of the end portions 48 is formed with a stress absorbing structure 45 adjacent to the respective one of the engaging portions 42 for absorbing stress applied to the base 4.

The base 4 further includes a diode-mounting part 43′ of the non-conductive material. The lead-mounting parts 43 are formed respectively on the engaging portions 42 of the main part 4′. The diode-mounting part 43′ is formed on the central portion 41 of the main part 4′, and is adapted for mounting of a light emitting diode 91 thereon. Preferably, the stress absorbing structure 45 is in the form of a trench formed in the respective one of the end portions 48 of the main part 4′. Each of the end portions 48 of the main part 4′ of the base 4 is formed with a screw hole 46.

As shown in FIGS. 2 and 3, the conductive leads 3 of the light emitting diode mounting seat 2 are electrically connected to the light emitting diode 91 through conductive wires 92. Formation of the lead-mounting parts 43 and the diode-mounting part 43′ can efficiently prevent short circuit from occurring.

In the preferred embodiment, the metallic material is Al or Al alloy, and the compound of the non-conductive material is an oxide of the metallic material, which is formed through anodizing techniques.

Furthermore, as shown in FIG. 3, the resin material 5 covers a portion of each of the conductive leads 3. The resin material 5 is formed on the engaging portions 42 of the main part 4′, surrounds the central portion 41 of the main part 4′, and defines a light departing opening 51.

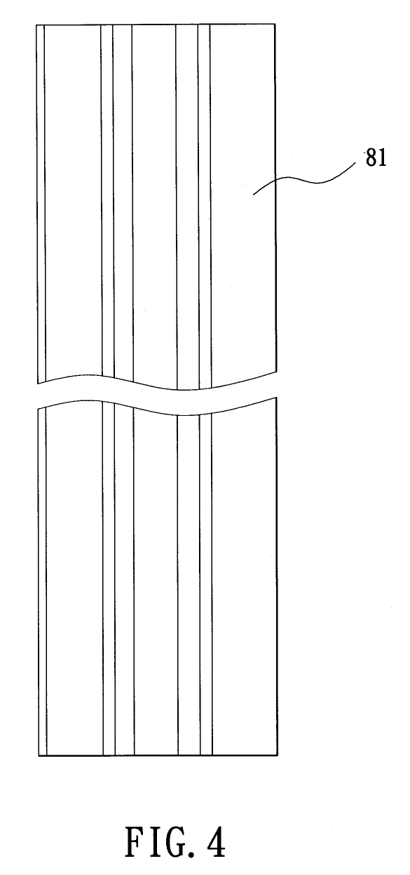

FIGS. 4 to 8 illustrate consecutive steps of a method for making the light emitting diode mounting seat 2. The method includes the steps of:

(a) forming a metallic extrudate 81 (see FIG. 4) through thermal extruding techniques;

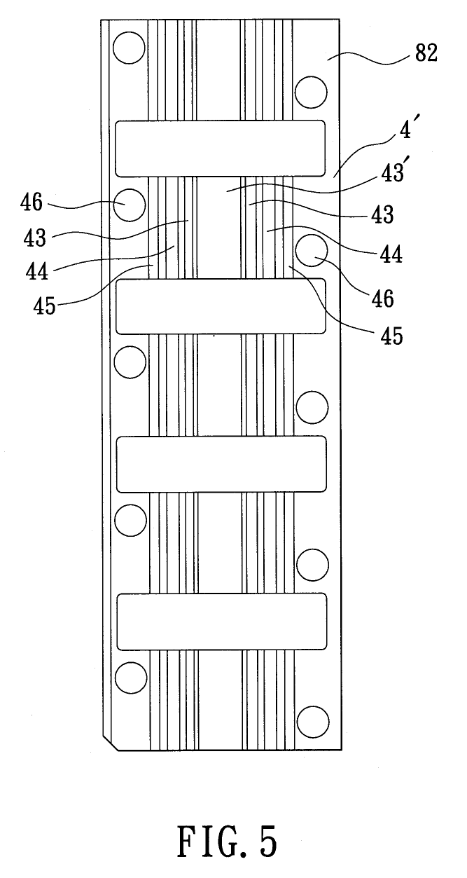

(b) punching the metallic extrudate 81 to form a base unit 82 including a plurality of base elements (see FIG. 5), each base element being formed with the protrusions 44, the stress absorbing structures 45, and the screw holes 46;

(c) treating the base unit 82 in such a manner to form each base element with the conductive main part 4′, the non-conductive lead-mounting parts 43, and the non-conductive diode-mounting part 43′ (see FIG. 5);

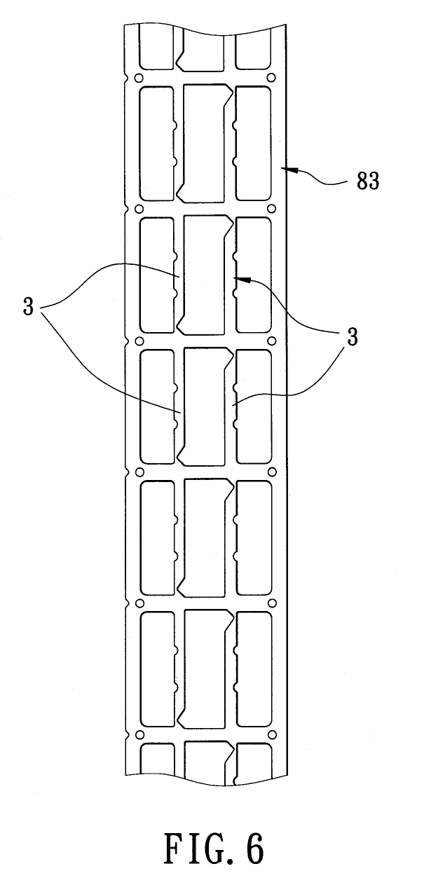

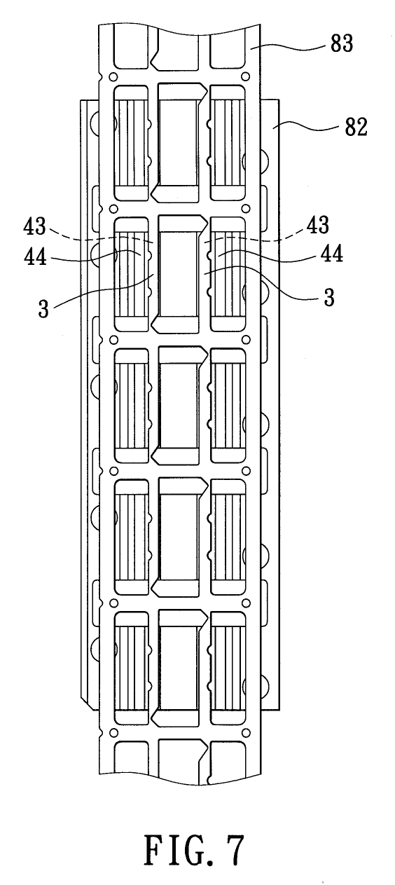

(d) assembling the base unit 82 with a lead frame 83 which includes a plurality of pairs of the conductive leads 3 (see FIG. 6) to form an assembly, and placing the assembly into a mold (not shown), each pair of the conductive leads 3 being aligned with a respective pair of the lead-mounting parts 43 (see FIG. 7), the lead frame 83 being made from a material of copper or gold-plated copper;

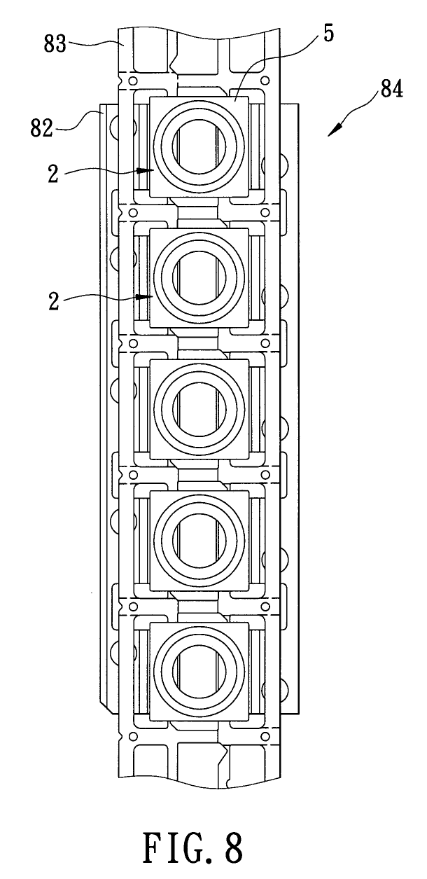

(e) injecting the resin material 5 into the mold so as to form a semi-finished product 84 (see FIG. 8); and

(f) cutting the semi-finished product 84 so as to form a plurality of the light emitting diode mounting seats 2.

When compared with the conventional method having the step of inserting bases 11 into the resin forming mold one after another, the method of this invention placing the assembly of the base unit 82, and the lead frame 83 into the mold has a higher productivity.

Preferably, the metallic extrudate 81 is of a material made from Al or Al alloy. The treatment of the base unit 82 instep (c) is conducted through anodizing techniques.

Furthermore, the anodizing treatment of the base unit 82 in step (c) can be conducted by disposing a shield (not shown) on the conductive main part 4′ such that anodizing of the metallic material occurs only on the lead-mounting parts 43 and the diode-mounting part 43′.

By forming the lead-mounting parts 43 and the diode-mounting part 43′ of the base 4 of the light emitting diode mounting seat 2 of this invention, the insulators 13 employed in the aforesaid conventional light emitting diode mounting seat 1 can be dispensed with, and the aforesaid drawbacks associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A light emitting diode mounting seat comprising:
a base having a conductive main part of a metallic material and a lead-mounting part of a non-conductive material containing a compound of said metallic material; and
a conductive lead mounted on said lead-mounting part.

2. The light emitting diode mounting seat of claim 1, further comprising a resin material bonded to said conductive lead and said base for securing said conductive lead to said base.

3. The light emitting diode mounting seat of claim 2, wherein said base and said resin material engage each other in a tongue-and-groove engaging manner.

4. The light emitting diode mounting seat of claim 3, wherein said main part of said base is formed with a protrusion, and said resin material is formed with a recess for extension of said protrusion therein.

5. The light emitting diode mounting seat of claim 4, wherein said main part of said base has an upper surface, said protrusion protruding from said upper surface and having a root end that terminates at said upper surface of said base, and a free end that is opposite to said root end and that has a cross-section greater than that of said root end.

6. The light emitting diode mounting seat of claim 2, wherein said main part of said base has a central portion, two opposite engaging portions extending from two opposite sides of said central portion, and two end portions extending respectively from said engaging portions, said engaging portions engaging said resin material in a tongue-and-groove engaging manner, each of said end portions being formed with a stress absorbing structure adjacent to the respective one of said engaging portions for absorbing stress applied to said base.

7. The light emitting diode mounting seat of claim 6, wherein said base further includes a diode-mounting part of said non-conductive material, said lead-mounting part being formed on a respective one of said engaging portions of said main part, said diode-mounting part being formed on said central portion of said main part and being adapted for mounting of a light emitting diode thereon.

8. The light emitting diode mounting seat of claim 6, wherein said stress absorbing structure is in the form of a trench formed in the respective one of said end portions of said main part.

9. The light emitting diode mounting seat of claim 6, wherein each of said end portions of said main part of said base is formed with a screw hole.

10. The light emitting diode mounting seat of claim 1, wherein said metallic material is selected from one of Al and Al alloy.

11. The light emitting diode mounting seat of claim 10, wherein said compound is an oxide of said metallic material.

12. The light emitting diode mounting seat of claim 2, wherein said resin material covers a portion of said conductive lead.

13. The light emitting diode mounting seat of claim 6, wherein said resin material is formed on said engaging portions of said main part, surrounds said central portion of said main part, and defines a light departing opening.

14. A method for making a light emitting diode mounting seat, comprising:
(a) forming a metallic extrudate through thermal extruding techniques;
(b) punching the metallic extrudate to form a base unit including a plurality of base elements;
(c) treating the base unit in such a manner to form each of the base elements with a conductive main part and a non-conductive lead-mounting part;
(d) assembling the base unit with a lead frame to form an assembly, and placing the assembly into a mold;
(e) injecting a resin material into the mold so as to form a semi-finished product; and
(f) cutting the semi-finished product so as to form a plurality of the light emitting diode mounting seats.

15. The method of claim 14, wherein the metallic extrudate is selected from one of Al and Al alloy.

16. The method of claim 15, wherein the treatment of the base unit in step (c) is conducted through anodizing techniques.
